(19) United States
(12) Patent Application Publication
(10) Pub. No.: US 2012/0194764 A1
(43) Pub. Date: Aug. 2, 2012

(54) LIQUID CRYSTAL DISPLAY DEVICE AND METHOD FOR MANUFACTURING LIQUID CRYSTAL DISPLAY DEVICE

(75) Inventor: Takashi Ishizumi, Osaka (JP)

(73) Assignee: Sharp Kabushiki Kaisha, Osaka (JP)

(21) Appl. No.: 13/499,873

(22) PCT Filed: Jun. 28, 2010
(86) PCT No.: PCT/JP2010/060993

§ 371 Date: Apr. 2, 2012

(30) Foreign Application Priority Data
Nov. 11, 2009 (JP) 2009 258011

(51) Int. Cl. G02F 1/13357; H01J 9/24

(52) U.S. Cl. 349/69; 349/71; 445/24

(57) ABSTRACT

A liquid crystal display device (1) includes: a liquid crystal display panel (10) for displaying an image; and a blue LED (32) for emitting light to the liquid crystal display panel (10). The liquid crystal display panel (10) includes a glass substrate (12) provided on the side on which the blue LED (32) is provided and a glass substrate (19) facing the glass substrate (12) via a liquid crystal layer (17). On the glass substrate (12), a fluorescent layer (13) configured to emit light of a plurality of different colors for displaying the image is provided so as to lie between the glass substrate (12) and the liquid crystal layer (17). The blue LED (32) is configured to emit blue light for exciting the fluorescent layer (13). This improves the use efficiency of light from a light source, and prevents a reduction in reliability and an increase in cost.

### TECHNICAL FIELD

The present invention relates to a liquid crystal display device which displays a color image and a method of producing a liquid crystal display device.

### BACKGROUND ART

Generally, a liquid crystal display device includes (i) a display panel in which a color filter is provided and (ii) a backlight serving as a light source which irradiates the display panel with light. The following description discusses, with reference to FIGS. 4 and 5, a configuration of such a liquid crystal display device and its problem.

FIG. 4 is a cross-sectional view illustrating how a main part of a generally-used liquid crystal display device is configured. FIG. 5 is a view describing a problem of the liquid crystal display device shown in FIG. 4.

As illustrated in FIG. 4, a liquid crystal display device 101 includes a liquid crystal display panel 110 and a backlight 130. The liquid crystal display panel 110 displays a color image. A plurality of pixels 125 including pixels 125R for displaying red color, pixels 125G for displaying green color, and pixels 125B for displaying blue color are arranged in the liquid crystal display panel 110.

The liquid crystal display panel 110 is constituted by a polarization plate 114, a glass substrate 112, a SiO₂ film 115, pixel electrodes 116, a liquid crystal layer 117, an upper electrode 118, a color filter 113, a glass substrate 119 and a polarization layer 120, which are arranged in this order from the side on which the backlight 130 is provided.

On the glass substrate 112, a plurality of TFTs 121 for driving pixels are arranged in such a way as to correspond to the respective pixels 125R, 125G and 125B. The liquid crystal layer 117 is enclosed in the liquid crystal display panel 110 and sealed with a seal 122. In the liquid crystal layer 115, a plurality of spacers 123 are dispersed, by which the thickness of the liquid crystal layer 115 is controlled.

The color filter 113 is provided on the glass substrate 119. The glass substrate 119 is one, of the glass substrates of the liquid crystal display panel 110, which is provided farther from the backlight 130. The color filter 113 includes a color filter 113R that transmits red (R) light, a color filter 113G that transmits green (G) light, and a color filter 113B that transmits blue (B) light. The color filter 113R is provided in each of the pixels 125R, the color filter 113G is provided in each of the pixels 123G, and the color filter 113B is provided in each of the pixels 125B. Further, a black matrix 113B1 is provided between adjacent ones of the color filters 113R, 113G and 113B.

The backlight 130 is a surface light source which emits white (W) light including all the spectra of visible light from red to blue.

The liquid crystal display device 101 carries out a color display by allowing white light emitted from the backlight 130 to pass through the color filters 113R, 113G and 113B.

As illustrated in FIG. 5, the backlight 130 emits white light 131W including red light 131R, green light 131G and blue light 131B.

The color filter 113R provided in the liquid crystal display panel 110 transmits a spectrum of the red light 131R but absorbs spectra of the green light 131G and of the blue light 131B, among the spectra of the red light 131R, the green light 131G and of the blue light 131B. Similarly, the color filter 113G transmits the spectrum of the green light 131G but absorbs the spectra of the red light 131R and of the blue light 131B. Further, the color filter 113B transmits the spectrum of the blue light 131B but absorbs the spectra of the green light 131G and of the red light 131R.

Since the color filters 113R, 113G and 113B absorb light like above, the energy of the white light 131W emitted from the backlight 130, which light has passed through the color filters 117R, 117G and 117B, is reduced to one third the energy before passing through the color filters. That is, since the liquid crystal display device 101 includes the color filter 113, the use efficiency of light in the liquid crystal display device 101 is reduced to one-third.

In order to prevent a reduction in the use efficiency of light which reduction is caused by the color filter absorbing light, there has been developed a liquid crystal display device including: a light source that emits UV light, in place of the white light source (backlight); and a liquid crystal display panel having, in place of the color filters, fluorescent substances (or phosphors) each of which emits red light, green light or blue light upon excitation by the UV light (e.g., Patent Literatures 1 to 3).

The following description discusses, with reference to FIG. 6, how a liquid crystal display device of Patent Literature 3 is configured. FIG. 6 is a cross-sectional view illustrating how the liquid crystal display device of Patent Literature 3 is configured.

The liquid crystal display device shown in FIG. 6 includes a plurality of UV light sources 239, a UV light-transmitting visible light-reflecting filter glass substrate 234, a polarization plate 237, a second glass substrate 230, a liquid crystal 233, a first glass substrate 220 and a polarization plate 238.

The first glass substrate 220 and the second glass substrate 230 face each other via the liquid crystal 233. On one surface (which faces the second glass substrate 230) of the first glass substrate 220, TFTs (not illustrated) and a plurality of pixel electrodes 221 adjacent to their corresponding TFTs are arranged. On the other surface of the first glass substrate 220, the polarization plate 238 is provided.

On one surface (which faces the first glass substrate 220) of the second glass substrate 230, a common electrode 231 is provided. On the other surface of the second glass substrate 230, the UV light-transmitting visible light-reflecting filter glass substrate 234 is provided.

The UV light-transmitting visible light-reflecting filter glass substrate 234 is configured such that ZnS and SiO₂ are alternately stacked on a quartz glass plate that transmits UV light. Further, a light emitting fluorescent material 236 including a blue light emitting fluorescent material B′, a green light emitting fluorescent material G′ and a blue light emitting fluorescent material B′ is provided on the UV light-transmitting visible light-reflecting filter glass substrate 234 in such a way as to correspond to the pixels. A black matrix pattern 235 is provided between adjacent ones of the red, green and blue light emitting fluorescent materials R′, G′ and B′. Further, the polarization plate 237 is provided on the light emitting fluorescent material 236. The polarization plate 237 is bonded to the other surface of the second glass substrate 230.

According to the liquid crystal display device configured like above, UV light emitted from the UV light sources 239 passes through the UV light-transmitting visible light-reflecting filter glass substrate 234 and then enters the light emitting fluorescent layer 236. Upon receiving the UV light, the light emitting fluorescent material 236 emits light corresponding to its colors. The light emitted from the light emitting fluorescent material 236 passes through the polarization plate 237, the second glass substrate 230, the common electrode 231, the liquid crystal 233, the pixel electrodes 221, the first glass substrate 220 and the polarization plate 238, and then is emitted toward the front surface side.

Patent Literature 4 discloses a liquid crystal display device using blue light as a light source for exciting a fluorescent material to emit light.

FIG. 7 is a cross-sectional view illustrating how the liquid crystal display device of Patent Literature 4 is configured.

The liquid crystal display device shown in FIG. 7 is constituted by a glass substrate 301, a fluorescent layer 303, a polarization layer 304, a thin strip transparent electrode 305, a liquid crystal layer 306, a thin strip transparent electrode 307, a polarization layer 308, a glass substrate 302, and a blue light emitting diode 320, which are arranged in this order from a viewer 330 side.

The fluorescent layer 303 includes fluorescent materials for emitting red light, for emitting green light and for emitting blue light arranged in the form of stripes or arranged checkerwise.

The blue light emitting diode 320 is combined with a light guide plate 321 and a reflection plate 322. The blue light emitting diode 320 emits light, which passes through the light guide plate 321 and serves as blue light 310. The blue light 310 then passes through the glass substrate 302, the polarization layer 308, the thin strip transparent electrode 307, the liquid crystal layer 306, the thin strip transparent electrode 305 and the polarization layer 304 in this order, and then enters the fluorescent layer 303. The fluorescent layer 303 emits light corresponding to its colors, and the light thus emitted passes through the glass substrate 301 and is emitted, as colored light, toward the viewer 330.

### Citation List

### Patent Literatures

Patent Literature 1

Japanese Patent Application Publication, Tokukaisho, No. 51-109798 A (Publication date: Sep. 28, 1976)

Patent Literature 2

Japanese Patent Application Publication, Tokukaisho, No. 63-216029 A (Publication date: Sep. 8, 1988)

Patent Literature 3

Japanese Patent Application Publication, Tokukaisho, No. 63-15221 A (Publication date: Jan. 22, 1988)

Patent Literature 4

Japanese Patent Application Publication, Tokukaihei, No. 11-237632 A (Publication date: Aug. 31, 1999)

Patent Literature 5

Japanese Patent Application Publication, Tokukaihei, No. 11-199781 A (Publication date: Jul. 27, 1999)

Patent Literature 6

Japanese Patent Application Publication, Tokukaihei, No. 9-245511 A (Publication date: Sep. 19, 1997)

### SUMMARY OF INVENTION

### Technical Problem

As has been described, since Patent Literatures 1 to 3 use no color filters, Patent Literatures 1 to 3 improve the use efficiency of light emitted from a light source.

However, in a case where light to enter a fluorescent substance or a phosphor is UV light as in the case of Patent Literatures 1 to 3, the following problem arises. That is, since a light source that emits UV light is high in energy density, the lifetime of a packaging material constituting the light source is shortened or the light source becomes less reliable. Further, Patent Literature 3 employs the UV light-transmitting visible light-reflecting filter glass substrate 234 in order to prevent attenuation of short-wavelength UV light for exciting fluorescent substances. The UV light-transmitting visible light-reflecting filter glass substrate 234 is very expensive and thus causes an increase in cost.

Further, according to Patent Literature 4, short-wavelength (i.e., high-energy) blue light 310 is allowed to pass through the liquid crystal layer 306 in order to excite the fluorescent materials for red light emission, for green light emission and for blue light emission, which are in the fluorescent layer 303. That is, the blue light 310 passes through the liquid crystal layer 306 even in a case where light other than blue light, such as red light or green light, is to be emitted.

This accelerates deterioration of the liquid crystal layer 306, and makes the liquid crystal display device less reliable.

Further, the blue light 310 emitted from the blue light emitting diode 320 passes through the polarization layer 308 and the liquid crystal layer 306 before reaching the fluorescent layer 303. Therefore, the energy of the blue light 310 is significantly attenuated to the extent that the blue light 310 is not intense enough to sufficiently excite the fluorescent layer 303. This causes a reduction in the emission intensity of the fluorescent materials of the fluorescent layer 303. Accordingly, the liquid crystal display device of Patent Literature 4 has a problem of luminance decrease.

The present invention has been made in view of the problems, and an object of the present invention is to improve the use efficiency of light emitted from a light source and to suppress a reduction in reliability and an increase in cost.

### Solution to Problem

In order to attain the above object, a liquid crystal display device in accordance with the present invention includes: a liquid crystal display panel for displaying an image; and a light source for emitting light to the liquid crystal display panel, the liquid crystal display panel including a first substrate and a second substrate, the first substrate being provided on a light source side and the second substrate facing the first substrate via a liquid crystal layer, on the first substrate, a fluorescent layer configured to emit light of a plurality of different colors for displaying the image being provided so as to lie between the first substrate and the liquid crystal layer, and the light source being configured to emit blue light for exciting the fluorescent layer.

In order to attain the above object, a method of producing a liquid crystal display device in accordance with the present invention is a method of producing a liquid crystal display device including (i) a liquid crystal display panel for displaying an image and (ii) a light source for emitting light to the liquid crystal display panel, said method, including the steps of: forming, on a first substrate, a fluorescent layer configured to emit light of a plurality of different colors for displaying the image; forming a liquid crystal layer by bonding a second substrate to the first substrate so as to sandwich the fluorescent layer and injecting liquid crystal into space between the first substrate and the second substrate, the second substrate being a counter substrate facing the first substrate; and locating the light source, which is configured to emit blue light, such that the blue light passes through the first substrate and then enters the fluorescent layer.

According to the configurations, the fluorescent layer is excited by the blue light emitted from the light source. The blue light is higher in energy than other visible light. Therefore, exciting the fluorescent layer by the blue light makes it possible to achieve the intensity high enough to sufficiently excite the fluorescent layer, and thus possible to display an image with high luminance.

On the other hand, the blue light is lower in energy than UV light. Therefore, the blue light applies lighter load on a circuit to drive the light source, as compared to the case where the light source that emits UV light is used as the light source for exciting the fluorescent layer. This improves reliability.

Further, using the blue light as the light source for exciting the fluorescent layer eliminates the need for providing, to the liquid crystal display panel, glass that transmits UV light and is made from an expensive material, unlike the case where the light source is UV light. This makes it possible to achieve the intensity high enough to sufficiently excite the fluorescent layer and to prevent cost increase.

Moreover, the fluorescent layer is provided on the first substrate so as to lie between the first substrate and the liquid crystal layer. The first substrate is one, of the first and second substrates facing each other via the liquid crystal layer, which is positioned on the light source side.

Therefore, the blue light emitted from the light source passes through the first substrate and then reaches the fluorescent layer. The fluorescent layer emits light upon excitation by the blue light from the light source. The light emitted by the fluorescent layer passes through the liquid crystal layer and the second substrate. In this way, an image is displayed on the liquid crystal display panel.

Accordingly, the amount of the blue light passing through the liquid crystal layer can be reduced, which blue light is high in energy and is emitted from the light source. This makes it possible to make the amount of the blue light passing through the liquid crystal layer small, for example as compared to the case where the fluorescent layer is provided on the second substrate. As such, it is possible to suppress deterioration of the liquid crystal layer, and thus possible to improve reliability.

Further, since the fluorescent layer is provided on the first substrate which is provided on the light source side, the distance between the light source and the fluorescent layer is short. In addition, there is no member (e.g., liquid crystal layer) that attenuates light between the light source and the fluorescent layer. Therefore, it is possible to achieve the intensity high enough to sufficiently excite the fluorescent layer, and thus possible to improve the luminance of an image to be displayed on the liquid crystal display panel.

Furthermore, since the fluorescent layer is capable of emitting light of a plurality of different colors for displaying the image, it is not necessary to provide a color filter. Since there is no light absorption by a color filter, it is possible to improve the use efficiency of light from the light source.

As described above, according to the configurations, it is possible to improve the use efficiency of light from the light source and to suppress a reduction in reliability and an increase in cost.

### Advantageous Effects of Invention

A liquid crystal display device in accordance with the present invention includes: a liquid crystal display panel for displaying an image; and a light source for emitting light to the liquid crystal display panel, the liquid crystal display panel including a first substrate and a second substrate, the first substrate being provided on a light source side and the second substrate facing the first substrate via a liquid crystal layer, on the first substrate, a fluorescent layer configured to emit light of a plurality of different colors for displaying the image being provided so as to lie between the first substrate and the liquid crystal layer, and the light source being configured to emit blue light for exciting the fluorescent layer.

A method of producing a liquid crystal display device in accordance with the present invention is a method of producing a liquid crystal display device including (i) a liquid crystal display panel for displaying an image and (ii) a light source for emitting light to the liquid crystal display panel, said method, including the steps of: forming, on a first substrate, a fluorescent layer configured to emit light of a plurality of different colors for displaying the image; forming a liquid crystal layer by bonding a second substrate to the first substrate so as to sandwich the fluorescent layer and injecting liquid crystal into space between the first substrate and the second substrate, the second substrate being a counter substrate facing the first substrate; and locating the light source, which is configured to emit blue light, such that the blue light passes through the first substrate and then enters the fluorescent layer.

Accordingly, it is possible to improve the use efficiency of light from the light source while suppressing a reduction in reliability and an increase in cost.

### BRIEF DESCRIPTION OF DRAWINGS

FIG. 1 is a cross-sectional view illustrating how a main part of a liquid crystal display device in accordance with the first embodiment of the present invention is configured.

FIG. 2 is a view illustrating a modified example of a polarization layer of the liquid crystal display device.

FIG. 3 is a cross-sectional view illustrating how a main part of a liquid crystal display device in accordance with the second embodiment of the present invention is configured.

FIG. 4 is a cross-sectional view illustrating how a conventional liquid crystal display device is configured.

FIG. 5 is a view describing a problem of the liquid crystal display device shown in FIG. 4.

FIG. 6 is a cross-sectional view illustrating how a liquid crystal display device described in Patent Literature 3 is configured.

FIG. 7 is a cross-sectional view illustrating how a liquid crystal display device described in Patent Literature 4 is configured.

### DESCRIPTION OF EMBODIMENTS

### Embodiment 1

The following description discusses the first embodiment of the present invention in detail.

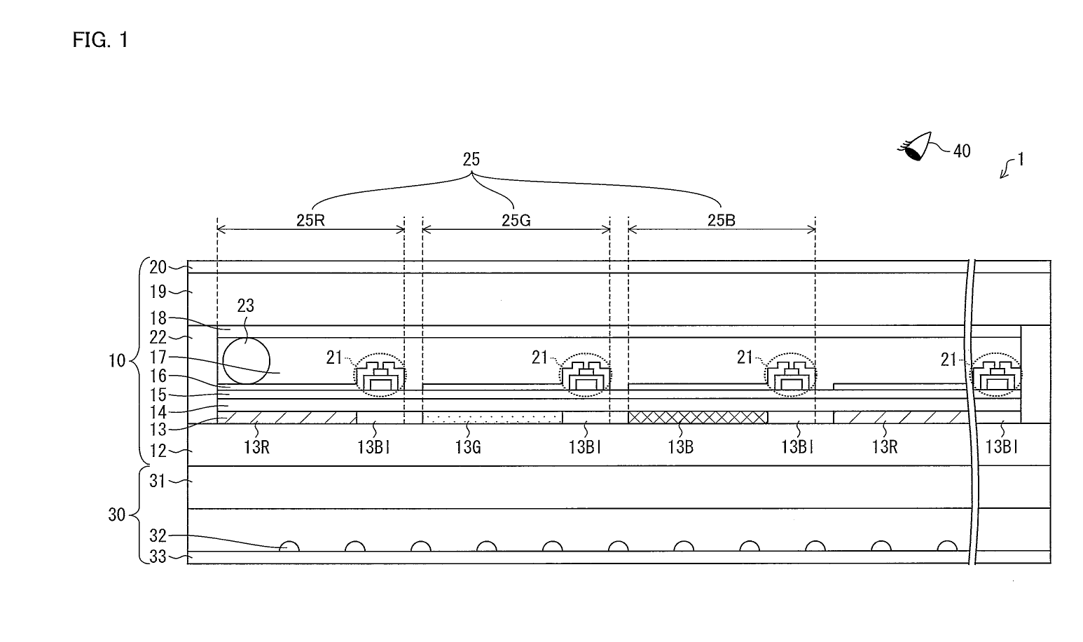

FIG. 1 is a cross-sectional view illustrating how a main part of a liquid crystal display device 1 in accordance with the first embodiment of the present invention is configured.

As illustrated in FIG. 1, the liquid crystal display device 1 includes a liquid crystal display panel 10 and a backlight 30.

The liquid crystal display panel 10 displays a color image with respect to a viewer 40. Note that, in the following description, a surface (side) of the liquid crystal display panel 10 on which surface an image is displayed is referred to as a front surface (side), and a surface (side) opposite to the front surface is referred to as a back surface (side). The backlight 30 is provided on the back surface side of the liquid crystal display panel 10. The backlight 30 includes: a plurality of blue LEDs (light emitting diodes) 32 each of which emits blue light and serves as a light source; a substrate 33 which supports the plurality of blue LEDs 32; and an optical sheet 31 for diffusing and collecting light emitted from the blue LEDs 32.

The optical sheet 31 diffuses and collects blue light emitted from the blue LEDs 32 in order to cause the blue light from the blue LEDs 32 to serve as a uniform surface light source. The optical sheet 31 used here can be a known optical sheet, and is made up of a stack of a plurality of optical sheets such as a diffusing plate, a diffusing sheet, a condensing lens sheet and/or the like (not illustrated).

Each of the blue LEDs 32 emits light to the liquid crystal display panel 10, and serves as a light source for exciting a fluorescent material (described later in detail) included in the liquid crystal display panel 10. A blue LED 32 consumes little electricity and has a long life. Therefore, using the blue LED 32 as a light source for exciting the fluorescent material makes it possible to reduce the power consumption of the liquid crystal display device 1 and to increase the lifetime of the liquid crystal display device 1. Further, using the blue LED 32 as the light source for exciting the fluorescent material allows for emission of light having a certain peak wavelength (about 460 nm), and thus allows for efficient excitation of the fluorescent material.

The emission wavelength of the blue LED 32 is preferably not less than about 400 nm but not more than about 530 nm, and further preferably not less than about 420 nm but not more than about 490 nm. Such an emission wavelength makes it possible to suppress deterioration of the fluorescent material, and to efficiently excite the fluorescent material.

The blue LED 32 can be made by for example a MOCVD method etc., as described in Patent Literature 5. That is, the blue LED 32 can be made by forming a semiconductor (e.g., InGaN) serving as a light emitting layer on a substrate.

It should be noted that the light source for exciting the fluorescent material is not limited to the blue LED 32, provided that the light source is capable of emitting blue light. The light source for exciting the fluorescent material may be for example electroluminescence (EL) that emits blue light, a cold cathode tube that emits blue light, or the like.

Further, the present embodiment is explained on the assumption that the backlight 30 is a direct backlight in which a plurality of blue LEDs 32 are arranged on a surface of the substrate 33. Note, however, that the backlight 30 may be a side backlight, which emits light in the form of plane emission by arranging the blue LEDs 32 on a lateral surface of a light guide plate and using the light guide plate and a reflection plate in combination.

The liquid crystal display panel 10 is an active matrix liquid crystal display panel in which a plurality of pixels 25 are arranged in a matrix manner so as to display a color image. The present embodiment is explained on the assumption that the pixels 25 include a plurality of pixels 25R for displaying red color of the color image, a plurality of pixels 25G for displaying green color of the color image, and a plurality of pixels 25B for displaying blue color of the color image.

The liquid crystal display panel 10 is constituted by a glass substrate (first substrate) 12, a fluorescent layer 13, a polarization layer 14, an insulation film 15, pixel electrodes 16, a liquid crystal layer 17, an upper electrode 18, a glass substrate (second substrate) 19, and a polarization plate 20, which are arranged in this order from the back surface side on which the backlight 30 is provided.

Further, TFTs 21 for driving the respective pixels 25R, 25G and 25B are arranged on the insulation film 15 in such a way as to correspond to the respective pixels 25R, 25G and 25B. In the liquid crystal layer 17, a plurality of spacers 23 are dispersed, by which the thickness of the liquid crystal layer 17 is controlled. The liquid crystal layer 17 is enclosed in the liquid crystal display panel 10, and sealed with a seal 22 provided at the edges of the glass substrate 12 and the glass substrate 19.

The glass substrate 12 is not particularly limited provided that it transmits blue light emitted from the backlight 30. Therefore, a glass material used in a usual liquid crystal display device can be used as the glass substrate 12, which glass material attenuates UV light wavelengths but transmits visible light wavelengths very well. The glass material is for example non-alkali glass. Examples of non-alkali glass usable as the glass substrate 12 include aluminosilicate glass.

That is, it is not necessary to configure the glass substrate 12 so that the glass substrate 12 transmits UV light, for example unlike the case of using UV light to excite the fluorescent layer 13. This eliminates the need for using, as the glass substrate 12, expensive quartz glass (Pyrex (registered trademark) glass) etc. in order to suppress attenuation of UV light.

It should be noted that, generally, glass is produced by mixing silicon dioxide (SiO₂) (called silicate) serving as a main component with various metal compounds serving as subcomponents. Soda glass (called blue plate glass), which is generally used as windowpanes of buildings, is produced by mixing sodium carbonate (Na₂CO₃)/calcium carbonate (CaCO₃) with silicon dioxide (SiO₂). Adding an alkaline component (soda) such as Na or Ca etc. reduces the glass transition temperature (melting point) of silicon dioxide, and thus achieves superior processability. However, adding an alkaline component (soda) such as Na or Ca etc. reduces transparency (glass becomes bluish) and increases thermal expansion rate.

On the other hand, non-alkali glass containing few alkaline components is necessary in order to produce the glass substrate 12 of the liquid crystal display device 1, because the glass substrate 12 is required (i) to have high transparency, (ii) to show little expansion and contraction during a high-temperature film production process for producing the TFTs 21 etc., and (iii) not to have an effect on the thin film characteristic (electrical properties) of the TFTs 21, etc. Easily-processable non-alkali glass containing no alkaline components is made by adding alumina to silicon dioxide. The glass substrate 12 of the liquid crystal display device 1 is made from aluminosilicate glass, which is non-alkali glass. Note, however, that such non-alkali glass is more expensive than soda glass.

The pixel electrodes 16 and the upper electrode 18 are transparent electrodes made from a transparent material such as ITO. The pixel electrodes 16 are connected with the respective TFTs 21 in such a way as to correspond to the respective pixels 25R, 25G and 25B. The upper electrode 18 functions as a common (COM) electrode. The liquid crystal layer 17 is driven by electric fields between the upper electrode 18 and the pixel electrodes 16 in units of pixels 25R, 25G and 25B. This controls the degree of openings (luminances) of the pixels 25R, 25G and 25B, thereby a color image is displayed.

The fluorescent layer 13 includes: a plurality of fluorescent materials 13R configured to emit red light upon excitation by blue light emitted from the blue LEDs 32; a plurality of fluorescent materials 13G configured to emit green light upon excitation by the blue light emitted from the blue LEDs 32; and a plurality of fluorescent materials 13B configured to emit blue light upon excitation by the blue light emitted from the blue LEDs 32. The fluorescent materials 13R are provided in respective apertures of the pixels 25R, the fluorescent materials 13G are provided in respective apertures of the pixels 25G, and the fluorescent materials 13B are provided in respective apertures of the pixels 25B.

Further a black BM 13B1 (black matrix) is provided between adjacent ones of the fluorescent materials 13R, 13G and 13B, in order to prevent mixing of light of different colors emitted by the fluorescent materials 13R, 13G and 13B (i.e., in order to prevent cross-talk). The BM 13B1 is not limited, provided that it is capable of preventing the cross-talk of light of different colors emitted by the fluorescent materials 13R, 13G and 13B. Therefore, instead of the BM 13B1, a reflective film serving as a divider may be provided between adjacent ones of the fluorescent materials 13R, 13G and 13B. The fluorescent materials 13R, 13G and 13B and the

BM 13B1 are stacked on the glass substrate 12. The fluorescent layer 13 can be formed by pattern printing by photolithography. Alternatively, the BM 13B1 (or the reflective film) may be formed as a bump in advance, and thereafter the fluorescent layer 13 may be formed by ink-jet printing.

A typical example of a fluorescent material 13R configured to emit red light is a Eu³⁺-activated fluorescent material, and a typical example of a fluorescent material 13G configured to emit green light is a Tb³⁺-activated fluorescent material. It is possible to use compounds of these fluorescent materials.

Alternatively, a red luminous body, a green luminous body and a blue luminous body as described in Patent Literature 6, such as those described below, can be used in a fluorescent material 13R, a fluorescent material 13G, and a fluorescent material 13B, respectively.

Examples of the red luminous body include: cyanine dyes such as 4-dicyanomethylene-2-methyl-6-(p- dimethylaminostyryl)-4H-pyran (DCM); and pyridine dyes such as 1-ethyl-2-(4-(p-dimethylaminophenyl)-1,3- butadienyl)-pyridium-perchlorate (pyridine 1). Any of these can be used in the fluorescent material 13R.

Examples of the green luminous body include: coumarin dyes such as 2,3,5,6-1H,4H-tetrahydro-8- trifluoromethylquinolizine (9,9a,1-gh) coumarin (coumarin 153), 3-(2′-benzothiazolyl)-7-diethylaminocoumarin (coumarin 6), and 3-(2′-benzoimidazolyl)-7-N ,N- diethylaminocoumarin (coumarin 30). Any of these can be used in the fluorescent material 13G.

As to the fluorescent material 13B, it is preferable that the fluorescent material 13B be made from a fluorescent material capable of converting the blue light emitted from the blue LEDs 32 into purer blue light. Examples of a blue luminous body include stilbene dyes such as 1,4-bis (2- methylstyrene) benzene and trans-4,4′-diphenylstilbene. Any of these can be used in the fluorescent material 13B.

The polarization layer 14 is stacked on the fluorescent layer 13 and the BM 13B1. That is, the polarization layer 14 is provided between the fluorescent layer 13 and the liquid crystal layer 17. The polarization layer 14 can be for example a wire grid polarizer having a thin metal wire structure, which is such that thin metal wires are arranged with a pitch smaller than a wavelength of visible light. The wire grid polarizer has excellent optical performance (excellent polarization property), and can have a submicron thickness. In addition, since the wire grid polarizer is constituted by thin metal wires, the wire grid polarizer is resistant to high-temperature treatment and to solvents. Therefore, the wire grid polarizer is suitable as a polarizer (so-called in-cell polarizer) provided inside a liquid crystal cell (i.e., between the glass substrates 12 and 19).

Such thin metal wires can be formed from a known material. Examples of the material for the thin metal wires include: metals such as aluminum, silver, gold, copper, molybdenum, tantalum, tin, nickel, indium, magnesium, iron, chromium, and silicon; or alloys containing any of these metals.

Note here that, according to a generally-known method of producing the wire grid polarizer, the wire grid polarizer is produced by (i) forming a thin metallic film by vapor deposition (or sputtering) and thereafter (ii) carrying out patterning by exposure and chemical etching by photolithography.

Note, however, that the polarization layer 14 is provided between the fluorescent layer 13 and the liquid crystal layer 17. According to the present embodiment, the polarization layer 14 is stacked directly on the fluorescent layer 13. That is, the fluorescent layer 13 and the polarization layer 14 are formed so as to be in contact with each other.

Under such circumstances, if exposure and chemical etching by photolithography are carried out to pattern a thin metallic film that is formed on the fluorescent layer 13 and is to be formed into the polarization layer 14, the fluorescent layer 13 may be damaged due to exposure and may deteriorate due to chemical agents.

In order to prevent the fluorescent layer 13 from deteriorating like above, it is preferable to form the wire grid polarizer (i.e., the polarization layer 14) by nanoimprinting (a method of directly printing thin metal wires with use of a fine mold). The nanoimprinting eliminates the need for carrying out exposure and using chemical agents for etching. This prevents the fluorescent layer 13 from being damaged due to exposure and deteriorating due to chemical agents for etching. Accordingly, it is possible to prevent a reduction in color purity of red light emitted by the fluorescent material 13B, green light emitted by the fluorescent material 13G, and of blue light emitted by the fluorescent material 13B. This makes it possible to prevent deterioration in quality of a color image displayed on the liquid crystal display device 1.

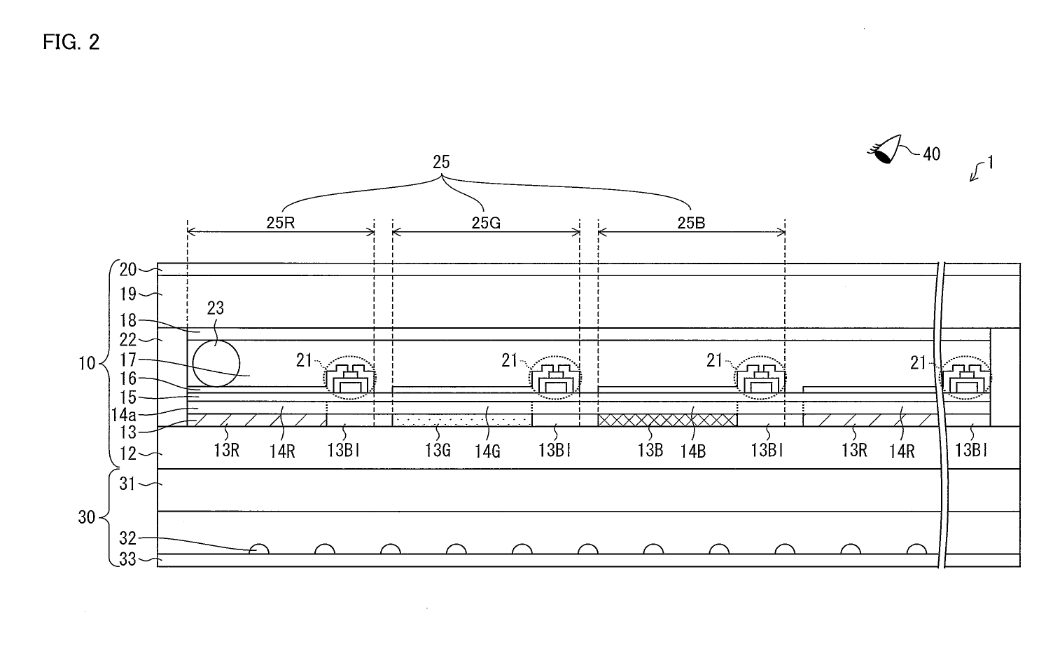

The polarization layer 14 can be configured such that the pitch of the thin metal wires varies from region to region which are stacked on the respective fluorescent materials 13R, 13G and 13B (see FIG. 2).

FIG. 2 is a view illustrating a modified example of the polarization layer 14 of the liquid crystal display device 1.

A polarization layer 14a is the same as the polarization layer 14, except that the polarization layer 14a includes a region 14R stacked on each of the fluorescent materials 13R, a region 14G stacked on each of the fluorescent materials 13G, and a region 14B stacked on each of the fluorescent materials 13B.

The region 14R, the region 14G and the region 14B transmit light of a plurality of respective different colors, i.e., red light, green light and blue light, emitted by the fluorescent layer 13. The region 14R transmits light having a longer wavelength, and the regions 14G and 14B each transmit light having a shorter wavelength. The polarization layer 14a is configured such that the pitch of the thin metal wires of the wire grid polarizer is smaller in the regions 14G and 14B than in the region 14R, and is smaller in the region 14B than in the regions 14R and 14G.

According to the wire grid polarizer serving as the polarization layer 14a, a ratio of transmission to extinction is low in the case of light having a shorter wavelength, among different kinds of light emitted by the respective fluorescent materials 13R, 13G and 13B. Therefore, it is preferable that, in the regions 14R, 14G and 14B of the polarization layer 14a, the pitch of the thin metal wires be smaller in a region that transmits light having a shorter wavelength.

That is, the polarization layer 14a is preferably configured such that the pitch of the thin metal wires is (i) smaller in the region 14G which transmits green light than in the region 14R which transmits red light and (ii) smaller in the region 14B that transmits blue light than in the region 14G which transmits green light.

This makes it possible to improve the ratio of transmission to extinction of light having a short wavelength, and thus possible to achieve excellent polarization property.

Alternatively, an organic polymer material such as a derivative or a guest-host linear liquid crystal polymer as described in Patent Literature 4 can be used as the polarization layer 14. Note, however, that the wire grid polarizer is highly resistant to heat as compared to the organic polymer material such as the derivative or the guest-host linear liquid crystal polymer, and can withstand high temperatures from about 300° C. to 350° C. at which a conventional TFT film formation process is carried out.

For this reason, using the wire grid polarizer as the polarization layer 14 makes it possible to employ a conventional TFT film formation process, which necessitates high-temperature processes and is suitable for a liquid crystal display panel 10 including no polarization layer 14. That is, since the conventional TFT film formation process can be carried out after the polarization layer 14 is provided, it is not necessary to modify the TFT film formation process. Accordingly, there is no increase in cost.

As described above, using the wire grid polarizer as the polarization layer 14 makes it possible to reduce the thickness of the liquid crystal display device 1, and to efficiently excite the fluorescent layer 13 by blue light emitted from the blues LED 21 with no increase in production cost.

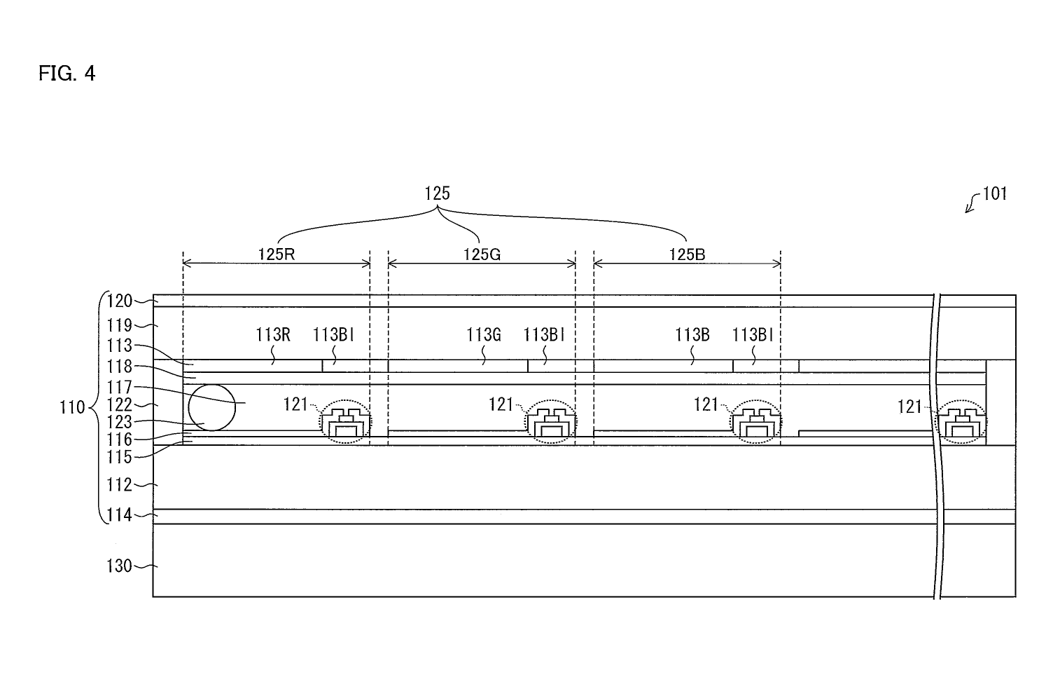

Further, since the polarization layer 14 is provided inside the liquid crystal display panel 10, it is not necessary for the liquid crystal display panel 10 to have three glass substrates. This is different from the liquid crystal display device shown in FIG. 4, i.e., the liquid crystal display device configured such that (i) the polarization plate 237 is provided outside of the second glass substrate 230 and the first glass substrate 220 and (ii) the UV light-transmitting visible light-reflecting filter glass substrate 234 is further provided for the purpose of suppressing attenuation of UV light. Accordingly, there is no increase in cost.

That is, since the polarization layer 14 is provided inside the liquid crystal display panel 10 and is stacked on the fluorescent layer 13, light from the blue LEDs 32 is not attenuated by the polarization layer 14. Accordingly, two glass substrates, i.e., the glass substrates 12 and 19, are sufficient to form the liquid crystal display device 10. This prevents cost increase.

Further, a polarization layer, i.e., the polarization layer 14, is stacked directly on the fluorescent layer 13 by nanoimprinting. This eliminates the need for carrying out photolithography to pattern the polarization layer 14. Accordingly, it is possible to prevent the fluorescent layer 13 from being damaged due to exposure and from deteriorating due to chemical agents for etching. As such, it is possible to prevent light from the blue LEDs 32 from being attenuated by the polarization layer 14, and to prevent deterioration of color purity of light emitted by the fluorescent layer 13.

The insulation film 15 is stacked on the polarization layer 14. The insulation film 15 can be made for example from SiO₂, and serves as a protection film for protecting the fluorescent layer 13 and the polarization layer 14. Since the fluorescent layer 13 is hermetically sealed between the glass substrate 12 and the insulation film 15 like above, it is possible to prevent oxidative degradation of the fluorescent materials 13R, 13G and 13B when these are excited to emit light. This makes it possible to extend the lifetime of the fluorescent materials 13R, 13G and 13B.

The pixel electrodes 16 and the TFTs 21 are stacked on the insulation film 15. The positions of the pixel electrodes 16 and the TFTs 21 are determined by mask alignment so that the pixel electrodes 16 and the TFTs 21 are arranged in positions in the pixels 25R, 25G and 25B where they should be, in which pixels 25R, 25G and 25B the respective fluorescent materials 13R, 13G and 13B are provided. The configuration of each of the TFTs 21 is not particularly limited, and therefore each of the TFTs 21 may have a known configuration.

The glass substrate 19 is a counter substrate that faces the glass substrate 12 via the liquid crystal layer 17, on which glass substrate 12 the pixel electrodes 16 and the TFTs 21 are provided. The glass substrate 19 can be made from the same material as that for the aforementioned glass substrate 12. On the glass substrate 19, the upper electrode 18 is provided.

The glass substrate 19 on which the upper electrode 18 is provided is bonded to the glass substrate 12 on which the pixel electrodes 16 and the TFTs 21 are provided. Then, liquid crystal is injected through an injection hole, and the injection hole is sealed with the seal 22. In this way, the liquid crystal layer 17 is formed.

Then, the polarization plate 20 is attached to the outside (opposite to the side on which the liquid crystal layer 17 is provided) of the glass substrate 19. This completes the liquid crystal display panel 10. On the outside (opposite to the side on which the liquid crystal layer 17 is provided) of the glass substrate 12 of such a liquid crystal display panel 10, the optical sheet 31 of the backlight 30 is located. In this way, the glass substrate 12, which is one of the glass substrates 19 and 12 of the liquid crystal display panel 10, is provided on the light source (blue LEDs 32) side.

The blue light emitted from the blue LEDs 32 passes through the optical sheet 31 and the glass substrate 12, and enters the fluorescent materials 13R, 13G and 13B serving as color layers. This excites the fluorescent materials 13R, 13G and 13B. The fluorescent materials 13R, 13G and 13B thus excited by the blue light emitted from the blue LEDs 32 emit red light, green light and blue light, respectively. Then, the red light, green light and blue light emitted by the fluorescent materials 13R, 13G and 13B pass through the polarization layer 14, the insulation film 15, the pixel electrodes 16, the liquid crystal layer 17, the upper electrode 18, the glass substrate 19 and the polarization plate 20, so as to be observed as a color image by the viewer 40. That is, the red light, green light and blue light emitted by the fluorescent materials 13R, 13G and 13B pass through their corresponding pixels 25R, 25G and 25B, thereby the red light, green light and blue light are subjected to intensity modulation (luminance adjustment) that depends on the degree of openings of the pixels 25R, 25G and 25B. This allows the liquid crystal display device 1 to display a full-color image.

As has been described, since the fluorescent materials 13R, 13G and 13B are excited by blue light that is higher in energy (i.e., has a shorter wavelength) than other visible light, the fluorescent materials 13R, 13G and 13B are excited sufficiently to emit sufficient light. Further, blue light is lower in energy than UV light. Therefore, the blue light applies lighter load on a circuit to drive the light source, as compared to the case where the fluorescent materials 13R, 13G and 13B are excited by UV light. As such, it is possible to improve reliability.

Note here that a relation between wavelength and energy can be represented by the following equation:

E=hc/λ

where E is energy [eV], λ is wavelength [nm], h is Planck constant, and c is speed of light.

As is clear from the above equation, the wavelength and energy of light are inversely correlated with each other. That is, light having a short wavelength is high in energy, whereas light having a long wavelength is low in energy. The fluorescent materials 13R, 13G and 13B (particularly the fluorescent materials 13R and 13G) are excited by high-energy light and emit low-energy light. The rest of the energy is absorbed by the fluorescent materials 13R, 13G and 13B, and is transformed into heat.

How the energy and heat are related to each other can be represented as below.

For example, in the case of blue light and green light, how the energy and heat are related to each other can be represented by the following equations:

Eb=Eg+T₁

where b is blue, g is green, Eb is energy of blue light emitted from a blue LED 32, Eg is energy of green light emitted by a fluorescent material 13G, and T₁ is quantity of heat.

Eb=hc/λb

Eg=hc/λg

where λb is wavelength of blue light emitted from a blue LED 32, and λg is wavelength of green light emitted by a fluorescent material 13G.

The relation between the energy and wavelength is represented by the following inequalities:

Eb>Eg, λb<λg

Similarly, in the case of blue light and red light, how the energy and heat are related to each other can be represented by the following equations:

Eb=Er+T₂

where r is red, Er is energy of red light emitted by a fluorescent material 13R, and T₂ is quantity of heat.

Er=hc/λr

where λr is wavelength of red light emitted by a fluorescent material 13R.

The relation between the energy and wavelength is represented by the following inequalities:

Eb>Er, λb<λr

It should be noted that, since Eb=Eg+T₁=Er+T₂, T₁ is smaller than T₂.

According to the liquid crystal display device 1, the three primary colors required for displaying color images are obtained from red light, green light and blue light emitted by the fluorescent material 13R, the fluorescent material 13G and the fluorescent material 13, respectively.

The fluorescent material 13R and the fluorescent material 13G emit red light and green light, respectively, upon excitation by blue light emitted from the blue LEDs 32. The blue light has a wavelength shorter than those of red light and green light.

Further, the fluorescent material 13B converts blue light emitted from the blue LEDs 32 into higher-color-purity blue light. That is, the fluorescent material 13B serves as a color conversion filter to make the color purity of the blue light emitted from the blue LEDs 32 uniform.

Since the fluorescent material 13B for converting the color purity of blue light emitted from the blue LEDs 32 is provided like above, it is possible to improve color tone and parallax. The liquid crystal display device 1 can be configured such that the color purity of blue light emitted from the blue LEDs 32 is converted by a color filter that transmits blue light, which color filter is provided in place of the fluorescent material 13B.

In a case where UV light is used as a light source, a glass substrate made from an expensive material such as quartz glass (Pyrex glass) is required in order to suppress attenuation of UV light passing through a glass substrate and thus to obtain sufficient excitation intensity for the fluorescent materials 13R, 13G and 13B. On the other hand, according to the liquid crystal display device 1, the fluorescent materials 13R, 13G and 13B are excited by blue light. This makes it possible to employ, as the glass substrate 12, a material that is used in a general liquid crystal display panel. Accordingly, it is possible to obtain sufficient excitation intensity for the fluorescent materials 13R, 13G and 13B with no increase in cost.

Further, the fluorescent layer 13 is provided directly on the glass substrate 12. That is, the fluorescent layer 13 is provided on the glass substrate 12 so as to lie between the glass substrate 12 and the liquid crystal layer 17. The glass substrate 12 is one, of the glass substrates 12 and 19 of the liquid crystal display device 10, which is positioned on the light source side. Accordingly, blue light emitted from the backlight 30 passes through only the glass substrate 12 and then excites the fluorescent materials 13R, 13G and 13B. That is, only the glass substrate 12 lies between the backlight 30 and the fluorescent layer 13.

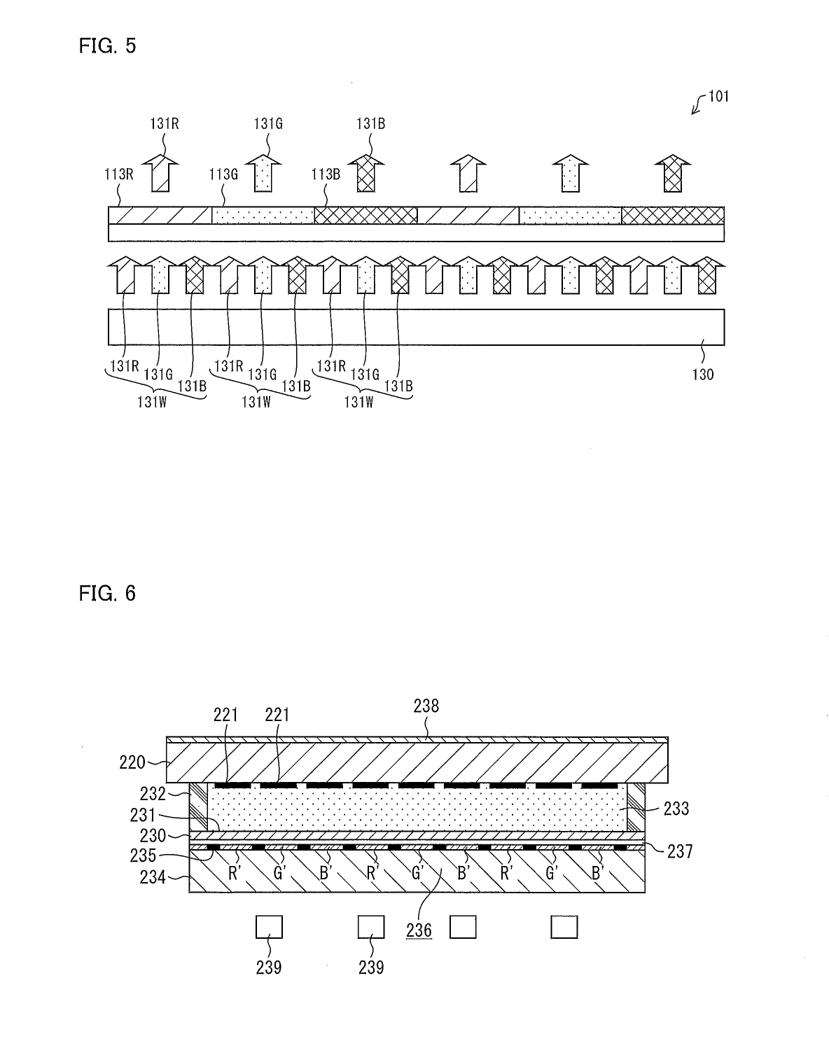

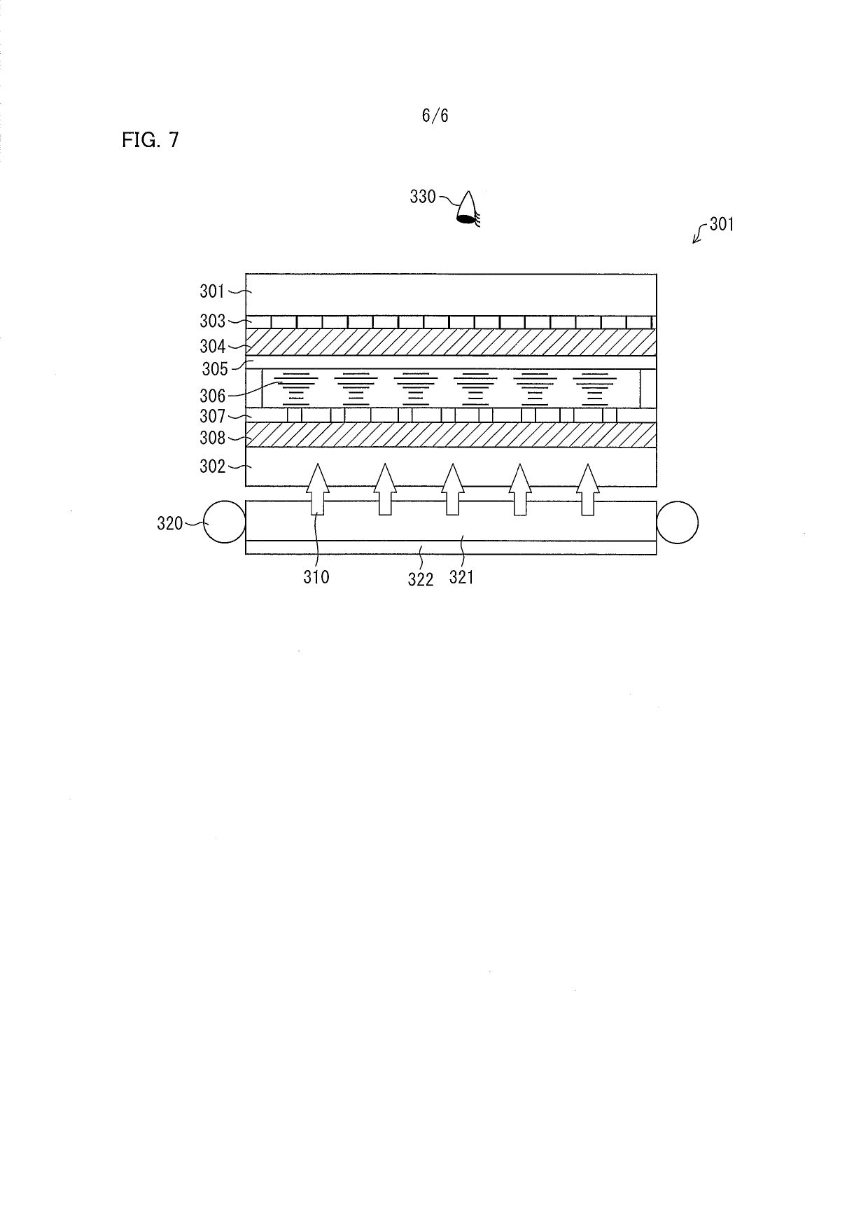

As such, it is possible to prevent a reduction in excitation intensity for the fluorescent layer 13, as compared to the case where the blue light 310 emitted from the light guide plate 321 passes through the glass substrate 302, the polarization layer 308, the liquid crystal layer 306 and the polarization layer 304 before exciting the fluorescent layer 303 (e.g., the liquid crystal display device of Patent Literature 4 described with reference to FIG. 5).

Furthermore, since the fluorescent layer 13 is provided on the glass substrate 12 which is positioned on the light source side, blue light emitted from the backlight 30 does not directly pass through the liquid crystal layer 17. The blue light is converted by the fluorescent layer 303 into red light and green light which are lower in energy than blue light, and then the red light and green light pass through the liquid crystal layer 17.

Accordingly, the amount of blue light passing through the liquid crystal layer 17 can be reduced as compared to the aforementioned liquid crystal display device shown in FIG. 5. This makes it possible to suppress deterioration of the liquid crystal layer 17, and thus possible to improve reliability.

Further, since the fluorescent layer 13 is provided on the glass substrate 12 which is positioned on the light source side, the distance between the backlight 30 and the fluorescent layer 13 is short. This makes it possible to reduce parallax, and possible to prevent mixing of light of different colors emitted by adjacent ones of the pixels 25R, 25G and 25B (i.e., to prevent cross-talk).

Moreover, according to the configuration of the liquid crystal display device 1, it is possible to display a full-color image by (i) exciting the fluorescent materials 13R, 13G and 13B provided in the respective pixels 25R, 25G and 25B to emit light and (ii) subjecting the light to intensity modulation which depends on the degree of openings of the respective pixels 25R, 25G and 25B. That is, according to the liquid crystal display device 1, it is possible to display a full-color image by use of red light, green light and blue light emitted by the fluorescent materials 13R, 13G and 13B. This eliminates the need for color conversion by a color filter. As such, it is not necessary for the liquid crystal display device 1 to include a color filter.

As has been described, the liquid crystal display device 1 displays a full-color image by use of red light, green light and blue light emitted by the fluorescent materials 13R, 13G and 13B, without using a color filter. This makes it possible to reduce optical loss due to a color filter by about 60% to 70%, and thus possible to increase the use efficiency of light from the backlight 30 by about three times, as compared to the case where the color filter is included. As such, it is possible to reduce power required for the backlight 30 to achieve a desired luminance of a screen to one-third.

Generally, a color filter has a color pigment dispersed therein in order to carry out color conversion. When light is scattered by the color pigment, a polarization effect of the light is partially canceled. As a result, light having passed through the color filter contains unwanted polarized component. When the light containing unwanted polarized component passes through an upper polarization plate (a polarization plate provided on the viewer side), the luminance of a higher-luminance region increases whereas the luminance of a lower-luminance region decreases, in the surface of an image display screen (this can be described such that white of a displayed image gains depth whereas black of the display image loses its depth). Such a problem causes a reduction in contrast of the displayed image.

In this regard, it is not necessary for the liquid crystal display device 1 to include a color filter. Therefore, the aforementioned problem does not arise in the liquid crystal display device 1. This makes it possible to increase the contrast as compared to a liquid crystal display device including a color filter.

In addition, as described earlier, the liquid crystal display device 1 has a configuration of an in-cell polarizer, i.e., the liquid crystal display device 1 is configured such that the polarization layer 14 is provided inside the liquid crystal display panel 10. Since the polarization layer 14 is provided inside the liquid crystal display panel 10 like above, it is possible to suppress cross-talk between adjacent ones of the pixels 25R, 25G and 25B, as compared to the case where the polarization layer 14 is provided outside the liquid crystal display panel 10 (i.e., between the glass substrate 12 and the backlight 30). Since the polarization layer 14 is provided inside the liquid crystal display panel 10 like above, it is possible to further suppress light leakage (stray light), and thus possible to further improve contrast.

### Embodiment 2

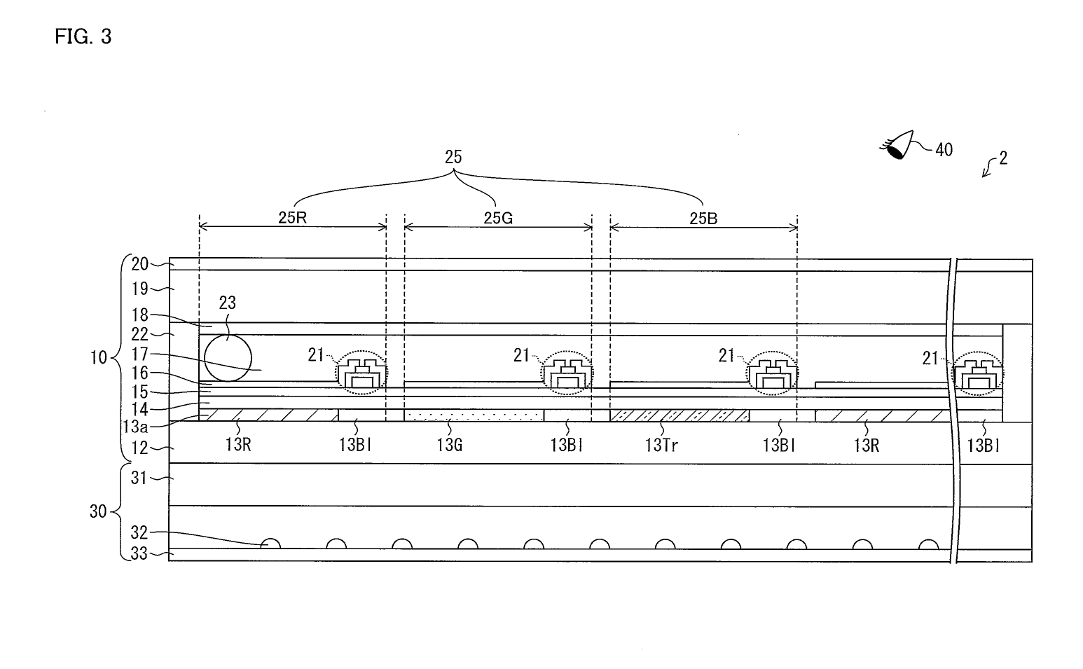

The following description discusses, with reference to FIG. 3, another embodiment of a display device of the present invention. FIG. 3 is a cross-sectional view illustrating how a main part of a liquid crystal display device 2 in accordance with the second embodiment of the present invention is configured. For convenience of description, members having functions identical to those illustrated in the drawings of Embodiment 1 are assigned identical referential numerals, and their descriptions are omitted here.

The liquid crystal display device 2 is different from the liquid crystal display device 1 in that the liquid crystal display device 2 (i) includes a fluorescent layer 13a in place of the fluorescent layer 13 of the liquid crystal display device 1 and (ii) further includes a transparent resin 13Tr.

The fluorescent layer 13a includes fluorescent materials 13R and fluorescent materials 13G, which emit light of respective two different colors. Further, the transparent resin 13Tr made from a transparent resin material is provided on the glass substrate 12 so as to be positioned in an aperture of each of the pixels 25B. The polarization layer 14 is stacked on the fluorescent layer 13a and the transparent resin 13Tr.

This allows red light emitted by the fluorescent materials 13R to go out through the pixels 25R, green light emitted by the fluorescent materials 13G to go out through the pixels 25G, and blue light which was emitted by the blue LEDs 32 and passed through the transparent resins 13Tr to go out through the pixels 25B.

According to the liquid crystal display device 2, among the three primary colors of light required for displaying a color image, red light and green light are emitted by the fluorescent materials 13R and the fluorescent materials 13G, respectively, whereas blue light is emitted from the blue LEDs 32.

That is, according to the liquid crystal display device 2, among the three primary colors of light required for displaying a color image, the blue light is obtained without using a color conversion filter etc. That is, the blue light is light that the blue LEDs 32 emit for the purpose of exciting the fluorescent materials 13R and 13G.

As such, the liquid crystal display device 2 is advantageous in that absorption of light and transmission loss are small and thus the use efficiency of light is high, as compared to the case where the blue light of the three primary colors of light required for displaying a color image is obtained by using a color conversion filter etc.

Further, since the transparent resins 13Tr are provided between the glass substrate 12 and the polarization layer 14 so as to be positioned in the apertures of the pixels 25B, it is possible to prevent the polarization layer 14 from having surface irregularities.

The liquid crystal display device 2 can be configured such that no transparent resins 13Tr are formed in the pixels 25B. That is, in the apertures of the pixels 25B, the polarization layer 14 can be stacked on the glass substrate 12.

This makes it possible to prevent blue light emitted from the blue LEDs 32 from being absorbed by the transparent resins 13Tr. As such, it is possible to further improve the use efficiency of blue light emitted from the blue LEDs 32.

The present invention is not limited to the descriptions of the respective embodiments, but may be altered within the scope of the claims. An embodiment derived from a proper combination of technical means disclosed in different embodiments within the scope of the claims is encompassed in the technical scope of the invention.

As has been described, a liquid crystal display device in accordance with the present invention includes: a liquid crystal display panel for displaying an image; and a light source for emitting light to the liquid crystal display panel, the liquid crystal display panel including a first substrate and a second substrate, the first substrate being provided on a light source side and the second substrate facing the first substrate via a liquid crystal layer, on the first substrate, a fluorescent layer configured to emit light of a plurality of different colors for displaying the image being provided so as to lie between the first substrate and the liquid crystal layer, and the light source being configured to emit blue light for exciting the fluorescent layer.

In order to attain the aforementioned object, a method of producing a liquid crystal display device in accordance with the present invention is a method of producing a liquid crystal display device including (i) a liquid crystal display panel for displaying an image and (ii) a light source for emitting light to the liquid crystal display panel, said method, including the steps of: forming, on a first substrate, a fluorescent layer configured to emit light of a plurality of different colors for displaying the image; forming a liquid crystal layer by bonding a second substrate to the first substrate so as to sandwich the fluorescent layer and injecting liquid crystal into space between the first substrate and the second substrate, the second substrate being a counter substrate facing the first substrate; and locating the light source, which is configured to emit blue light, such that the blue light passes through the first substrate and then enters the fluorescent layer.

According to the configurations, the fluorescent layer is excited by the blue light emitted from the light source. The blue light is higher in energy than other visible light. Therefore, exciting the fluorescent layer by the blue light makes it possible to achieve the intensity high enough to sufficiently excite the fluorescent layer, and thus possible to display an image with high luminance

On the other hand, the blue light is lower in energy than UV light. Therefore, the blue light applies lighter load on a circuit to drive the light source, as compared to the case where the light source that emits UV light is used as the light source for exciting the fluorescent layer. This improves reliability.

Further, using the blue light as the light source for exciting the fluorescent layer eliminates the need for providing, to the liquid crystal display panel, glass that transmits UV light and is made from an expensive material, unlike the case where the light source is UV light. This makes it possible to achieve the intensity high enough to sufficiently excite the fluorescent layer and to prevent cost increase.

Moreover, the fluorescent layer is provided on the first substrate so as to lie between the first substrate and the liquid crystal layer. The first substrate is one, of the first and second substrates facing each other via the liquid crystal layer, which is positioned on the light source side.

Therefore, the blue light emitted from the light source passes through the first substrate and then reaches the fluorescent layer. The fluorescent layer emits light upon excitation by the blue light from the light source. The light emitted by the fluorescent layer passes through the liquid crystal layer and the second substrate. In this way, an image is displayed on the liquid crystal display panel.

Accordingly, the amount of the blue light passing through the liquid crystal layer can be reduced, which blue light is high in energy and is emitted from the light source. This makes it possible to make the amount of the blue light passing through the liquid crystal layer small, for example as compared to the case where the fluorescent layer is provided on the second substrate. As such, it is possible to suppress deterioration of the liquid crystal layer, and thus possible to improve reliability.

Further, since the fluorescent layer is provided on the first substrate which is provided on the light source side, the distance between the light source and the fluorescent layer is short. In addition, there is no member (e.g., liquid crystal layer) that attenuates light between the light source and the fluorescent layer. Therefore, it is possible to achieve the intensity high enough to sufficiently excite the fluorescent layer, and thus possible to improve the luminance of an image to be displayed on the liquid crystal display panel.

Furthermore, since the fluorescent layer is capable of emitting light of a plurality of different colors for displaying the image, it is not necessary to provide a color filter. Since there is no light absorption by a color filter, it is possible to improve the use efficiency of light from the light source.

As described above, according to the configurations, it is possible to improve the use efficiency of light from the light source and to suppress a reduction in reliability and an increase in cost.

It is preferable that the liquid crystal display device further include a polarization layer which lies between the fluorescent layer and the liquid crystal layer.

According to the configuration, the polarization layer is provided between the fluorescent layer and the liquid crystal layer. Therefore, it is possible to prevent blue light from being attenuated in the polarization layer, which blue light is emitted from the light source for the purpose of exciting the fluorescent layer. This makes it possible to efficiently excite the fluorescent layer by light emitted from the light source.

The liquid crystal display device is preferably configured such that the light of the plurality of different colors emitted by the fluorescent layer includes at least red light and green light. According to the configuration, it is possible to display a color image by use of the red light and the green light emitted by the fluorescent layer and the blue light emitted from the light source.

The liquid crystal display device is preferably configured such that the light of the plurality of different colors emitted by the fluorescent layer includes blue light. According to the configuration, it is possible to improve image quality by using a fluorescent material that emits blue light purer than the blue light emitted from the light source.

The liquid crystal display device is preferably configured such that the polarization layer is a wire grid polarizer. According to the configuration, since the wire grid polarizer has excellent optical performance as a polarization layer, the film thickness of the polarization layer can be reduced. Further, since the wire grid polarizer is highly resistant to heat, the wire grid polarizer can withstand high temperatures suitable for a process of producing a liquid crystal display device in which no polarization layer is provided inside the liquid crystal display panel. As such, it is possible to provide the polarization layer between the fluorescent layer and the liquid crystal layer, without making a significant change to the process so that the process becomes suitable for providing the polarization layer inside the liquid crystal display panel.

Accordingly, it is possible to reduce the thickness of the liquid crystal display device, and possible to efficiently excite the fluorescent layer by blue light emitted from the light source with no increase in cost.

The liquid crystal display device is preferably configured such that the polarization layer has regions that transmit the light of the respective plurality of different colors emitted by the fluorescent layer, the polarization layer being arranged such that a pitch of thin metal wires constituting the wire grid polarizer is smaller in a region that transmits light having a shorter wavelength than in a region that transmits light having a longer wavelength.

According to the configuration, it is possible to prevent the ratio of transmission to extinction from being reduced due to the polarization plate, even in the case of light having a shorter wavelength than those of other light emitted by the fluorescent layer. This achieves excellent polarization property.

The liquid crystal display device is preferably configured such that the light source is a light emitting diode. According to the configuration, since a light emitting diode consumes little electricity and has a long life, it is possible to reduce the power consumption of the liquid crystal display device and to increase the lifetime of the liquid crystal display device.

The liquid crystal display device is preferably configured such that pixels include a first plurality of pixels for displaying red color, a second plurality of pixels for displaying green color, and a third plurality of pixels for displaying blue color; a first fluorescent layer configured to emit the red light is provided in each of the first plurality of pixels; a second fluorescent layer configured to emit the green light is provided in each of the second plurality of pixels; and transparent resin made from a transparent resin material is provided in each of the third plurality of pixels.

According to the configuration, among the three primary colors of light required for displaying a color image, red light and green light are emitted by the fluorescent layer configured to emit red light and the fluorescent layer configured to emit green light, respectively. On the other hand, blue light of the three primary colors of light is emitted from the light source.

As such, absorption of light and transmission loss are small and thus the use efficiency of light is high, as compared to the case where the blue light of the three primary colors of light required for displaying a color image is obtained by using a color conversion filter etc.

The liquid crystal display device is preferably configured such that the first substrate is made from non-alkali glass. According to the configuration, (i) the fluorescent layer is provided on the first substrate so as to lie between the first substrate and the liquid crystal layer and (ii) the light source emits blue light for exciting the fluorescent layer. Therefore, it is possible to use, as the first substrate, a glass material such as non-alkali glass for use in a usual liquid crystal display device, which material significantly attenuates UV light wavelengths but transmits visible light wavelengths very well.

Accordingly, it is not necessary to configure the first glass substrate so that the first glass substrate transmits UV light, for example unlike the case of using UV light to excite the fluorescent layer. This eliminates the need for using, as the first glass substrate, expensive quartz glass (Pyrex glass) etc. in order to suppress attenuation of UV light.

It is preferable that the method of producing the liquid crystal display device further include the step of forming a polarization layer so that the polarization layer is stacked on the fluorescent layer formed on the first substrate.

According to the configuration, the polarization layer is to be provided between the fluorescent layer and the liquid crystal layer. Therefore, it is possible to prevent blue light from being attenuated in the polarization layer, which blue light is emitted from the light source for the purpose of exciting the fluorescent layer. This makes it possible to produce a liquid crystal display device capable of efficiently exciting the fluorescent layer by light emitted from the light source.

The method of producing the liquid crystal display device is preferably configured such that the polarization layer is formed by nanoimprinting. According to the configuration, it is not necessary to carry out exposure and to use chemical agents for chemical etching, which are employed when the polarization layer is formed for example by photolithography. Therefore, it is possible to prevent the fluorescent layer from being damaged due to exposure and deteriorating due to chemical agents. This makes it possible to produce a liquid crystal display device capable of preventing deterioration in quality of an image to be displayed.

### Industrial Applicability

A liquid crystal display device of the present invention displays a color image by use of light that a fluorescent material emits upon excitation by blue light. Therefore, the present invention is suitably applicable to a liquid crystal display device and a method of producing a liquid crystal display device, each of which is desired to consume less power and have higher luminance.

### Reference Signs List

1 Liquid Crystal Display Device
2 Liquid Crystal Display Device
10 Liquid Crystal Display Panel
12 Glass Substrate (First Substrate)
13 Fluorescent Layer
13a Fluorescent Layer
13R, 13G, and 13B Fluorescent Material
13Tr Transparent Resin
14 Polarization Layer
14a Polarization Layer
17 Liquid Crystal Layer
19 Glass Substrate (Second Substrate)
25 Pixel
25R, 25G, and 25B Pixel
30 Backlight
32 Blue LED (Light Source)

1. A liquid crystal display device comprising:
a liquid crystal display panel for displaying an image; and
a light source for emitting light to the liquid crystal display panel,
the liquid crystal display panel including a first substrate and a second substrate, the first substrate being provided on a light source side and the second substrate facing the first substrate via a liquid crystal layer,
on the first substrate, a fluorescent layer configured to emit light of a plurality of different colors for displaying the image being provided so as to lie between the first substrate and the liquid crystal layer, and
the light source being configured to emit blue light for exciting the fluorescent layer.

2. The liquid crystal display device according to claim 1, further comprising a polarization layer which lies between the fluorescent layer and the liquid crystal layer.

3. The liquid crystal display device according to claim 1, wherein the light of the plurality of different colors emitted by the fluorescent layer includes at least red light and green light.

4. The liquid crystal display device according to claim 3, wherein the light of the plurality of different colors emitted by the fluorescent layer includes blue light.

5. The liquid crystal display device according to claim 2, wherein the polarization layer is a wire grid polarizer.

6. The liquid crystal display device according to claim 5, wherein the polarization layer has regions that transmit the light of the respective plurality of different colors emitted by the fluorescent layer, the polarization layer being arranged such that a pitch of thin metal wires constituting the wire grid polarizer is smaller in a region that transmits light having a shorter wavelength than in a region that transmits light having a longer wavelength.

7. The liquid crystal display device according to claim 1, wherein the light source is a light emitting diode.

8. The liquid crystal display device according to claim 3, wherein:
pixels include a first plurality of pixels for displaying red color, a second plurality of pixels for displaying green color, and a third plurality of pixels for displaying blue color;
a first fluorescent layer configured to emit the red light is provided in each of the first plurality of pixels;
a second fluorescent layer configured to emit the green light is provided in each of the second plurality of pixels; and
transparent resin made from a transparent resin material is provided in each of the third plurality of pixels.

9. The liquid crystal display device according to claim 1, wherein the first substrate is made from non-alkali glass.

10. A method of producing a liquid crystal display device, the liquid crystal display device including (i) a liquid crystal display panel for displaying an image and (ii) a light source for emitting light to the liquid crystal display panel,
said method, comprising the steps of:
forming, on a first substrate, a fluorescent layer configured to emit light of a plurality of different colors for displaying the image;
forming a liquid crystal layer by bonding a second substrate to the first substrate so as to sandwich the fluorescent layer and injecting liquid crystal into space between the first substrate and the second substrate, the second substrate being a counter substrate facing the first substrate; and
locating the light source, which is configured to emit blue light, such that the blue light passes through the first substrate and then enters the fluorescent layer.

11. The method according to claim 10, further comprising the step of forming a polarization layer so that the polarization layer is stacked on the fluorescent layer formed on the first substrate.

12. The method according to claim 1, wherein the polarization layer is formed by nanoimprinting.
